(19) United States
(12) Patent Application Publication
(10) Pub. No.: US 2021/0209593 A1
(43) Pub. Date: Jul. 8, 2021

(54) METHODS AND SYSTEMS FOR PUBLIC KEY INFRASTRUCTURE (PKI) ENABLED PRE-AUTHORIZED CREDIT CARD TRANSACTIONS

(71) Applicant: Capital One Services, LLC, McLean, VA (US)

(72) Inventors: Ayrton TRUJILLO, McLean, VA (US); Edmund CONNOR, McLean, VA (US)

(73) Assignee: Capital One Services, LLC, McLean, VA (US)

(21) Appl. No.: 16/737,079

(22) Filed: Jan. 8, 2020

(51) Int. Cl. G06Q 20/38; G06Q 20/34

(52) U.S. Cl. CPC G06Q 20/3829; G06Q 20/34; G06Q 20/3825

(57) ABSTRACT

Disclosed are systems and methods for public key infrastructure (PKI) enabled pre-authorized credit card transactions. For example, a method for granting limited transactional authorization from an account associated with a primary cardholder and a companion cardholder may include receiving a request to grant limited transactional authorization from the account for at least one transaction between the companion cardholder and a merchant, generating a response to the request, wherein the response includes at least one limitation, authenticating the response based on identification information of the primary cardholder, obtaining a private primary cardholder key upon authentication of the response, encrypting the response with the obtained private primary cardholder key, and transmitting the encrypted response for authorization of the at least one transaction according to the limitation.

### TECHNICAL FIELD

Various embodiments of the present disclosure relate generally to granting limited transactional authorization from an account associated with a primary cardholder to a companion cardholder.

### BACKGROUND

Certain groups of credit card users may be associated with, e.g., greater risk in being allowed access to a credit account, and/or may be inexperienced in managing a credit account and/or may require oversight to ensure that only approved expenses are made to a credit account. However, allowing such users access to credit accounts may be desirable, e.g., to allow a supervised amount of independence as part of a business plan, or to teach a user how to manage a credit account.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for public key infrastructure (PKI) enabled pre-authorized transactions, and in particular, granting limited transaction authorization from an account associated with a primary cardholder and a companion cardholder.

In one aspect, a method is disclosed of granting limited transactional authorization from an account associated with a primary cardholder and a companion cardholder. The method may include: receiving, via the one or more processors, a request to grant limited transactional authorization from the account for at least one transaction between the companion cardholder and a merchant; generating, via the one or more processors, a response to the request, wherein the response includes at least one limitation; authenticating, via the one or more processors, the response based on identification information of the primary cardholder; obtaining, via the one or more processors, a private primary cardholder key upon authentication of the response; encrypting, via the one or more processors, the response with the obtained private primary cardholder key; and transmitting, via the one or more processors, the encrypted response for authorization of the at least one transaction according to the limitation.

In another aspect, there is provided a method of granting limited transactional authorization from an account associated with a primary cardholder and a companion cardholder to the companion cardholder. The method may include: determining, via a primary cardholder device associated with the primary cardholder, a first transaction limitation for at least one transaction by the companion cardholder, wherein the first transaction limitation includes a maximum permissible amount for the at least one transaction; determining, via the primary cardholder device associated with the primary cardholder, a second transaction limitation for the at least one transaction, wherein the second transaction limitation includes an approved period of time during which the at least one transaction may occur; and approving, via the primary cardholder device associated with the primary cardholder, the at least one transaction from the account by the companion cardholder according to the first transaction limitation and the second transaction limitation.

In another aspect, there is provided a system for granting limited transactional authorization from an account associated with a primary cardholder and a companion cardholder. The system may include a memory storing instructions; and a processor executing the instructions to perform a process. The process may include: receiving a request transmitted by the companion cardholder to grant limited transactional authorization from the account, wherein the request includes one or more of a requested amount for the at least one transaction, a requested period of time during which the at least one transaction may occur, and a requested location at which the at least one transaction may occur; determining a first transaction limitation for at least one transaction by the companion cardholder based on the requested amount, wherein the first transaction limitation includes a maximum permissible amount for the at least one transaction; determining a second transaction limitation for the at least one transaction by the companion cardholder based on the requested period of time, wherein the second transaction limitation includes an approved period of time during which the at least one transaction may occur; determining a third transaction limitation for the at least one transaction by the companion cardholder based on the requested location at which the at least on transaction may occur, wherein the third transaction limitation includes an approved location for the at least one transaction; and approving the at least one transaction from the account by the companion cardholder according to the first transaction limitation, the second transaction limitation, and the third transaction limitation.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of granting limited transactional authorization, according to one or more embodiments.

FIG. 3 depicts a user interface on a user device, according to one or more embodiments.

FIGS. 4A-4B depict a user interface on a user device, according to one or more embodiments.

FIGS. 5A-5B depict a user interface on a user device, according to one or more embodiments.

FIG. 6 depicts a flowchart of an exemplary method for granting limited transactional authorization, according to one or more embodiments.

FIG. 7 depicts a flowchart of an exemplary method for granting limited transactional authorization, according to one or more embodiments.

FIG. 8 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

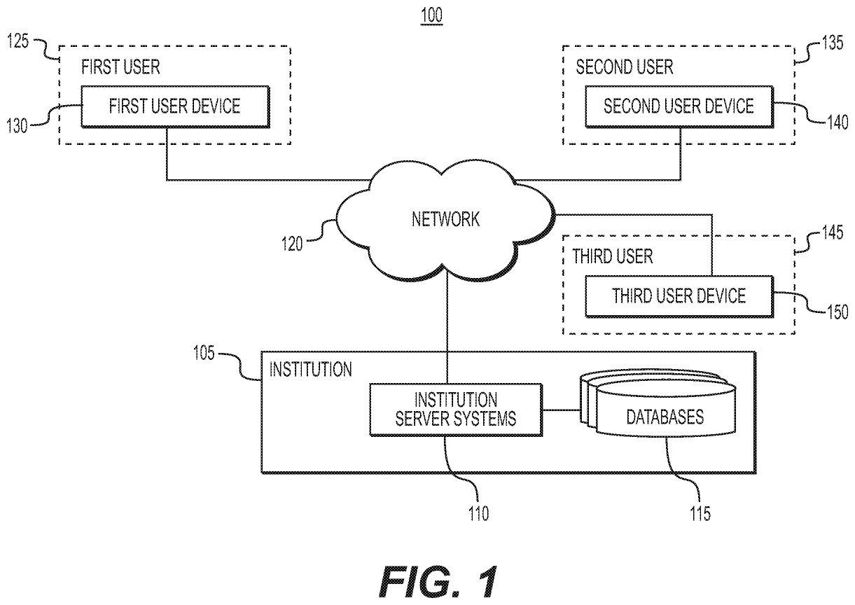

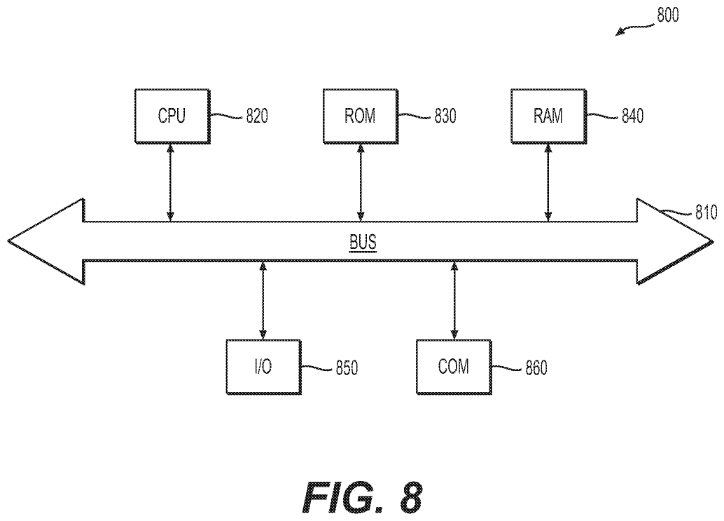

FIG. 1 depicts an exemplary environment of a system 100 for granting limited transactional authorization from an account associated with a first user 125 and a second user 135 according to some embodiments. As shown in FIG. 1, system 100 may include an institution 105 (e.g., a financial institution) having one or more institution server systems 110 (e.g., financial institution server systems) and one or more secured databases 115. The institution server systems 110 may include computing systems, such as system 800 described with respect to FIG. 8. As such, the institution server systems 110 may each include one or more processors and a memory for storing and executing applications or software modules of system 100. For example, the institution server systems 110 may include one or more software modules to communicate with user devices through a network 120, such as the Internet. Further, the one or more processors may be configured to access the memory and execute processor-readable instructions, which when executed by the processor configures the processor to perform a plurality of functions of the system 100 for granting limited transactional authorization from an account associated with the first user 125 and the second user 135.

The one or more secured databases 115 may store verification information of users, such as the first user 125, the second user 135, a third user 145, and/or customers or clients of institution 105. In some embodiments, the system 100 may utilize a public key infrastructure. In such embodiments, the one or more secured databases 115 may include one or more public keys. A public key may be derived from a private key and the public key may be used to verify digital signatures generated using the private key. The institution server systems 110 may be in communication with the one or more secured databases 115 such that the institution server systems 110 may obtain a public key associated with any user from the one or more secured databases 115 to verify requests transmitted by the user, as detailed further below. It is understood that the institution 105 may include any agency or organization that issues, collects, stores, and maintains public keys in relation to public key infrastructures.

Users, such as the first user 125, the second user 135, and the third user 145, may communicate with the institution server systems 110 through user devices, such as a first user device 130, a second user device 140, and a third user device 150, respectively. It is understood that the user devices, such as the first user device 130, the second user device 140, and the third user device 150, may be any type of computing device (e.g., personal computing device, mobile computing device, etc.). In some embodiments, the first user 125 may include a customer or client of institution 105. In an exemplary embodiment, the institution 105 may include a bank and the first user 125 may include a customer or client having a credit card with the bank (in which case the first user 125 may also be referred to as a credit card account holder). The first user 125 may alternatively, or additionally, have a bank account and/or a debit card account with the bank. In some embodiments, the second user 135 may be a non-authorized user of the credit card account held by the first user 125. In the context of the current disclosure, a “non-authorized user” may refer to a user who is not authorized by a financial institution (e.g., institution 105) to use a credit card account, but who is to be granted temporary or limited use of a credit card by an authorized user (e.g., a credit card account holder). Such additional non-authorized users may be added by a credit card account holder, such as the first user 125. In the context of the current disclosure, the credit card account holder may be referred to as a primary cardholder and a non-authorized user added to the credit card account held by the credit card account holder, e.g., the primary cardholder, may be referred to as a companion cardholder. While the embodiments disclosed herein are described with reference to the first user 125 as a credit card account holder and the second user 135 as a non-authorized user of the credit card account, it is understood that the embodiments disclosed herein may apply to instances in which the first user 125 may be a bank account holder and/or a debit card account holder and the second user 135 may be a non-authorized user of the bank account and/or the debit card account. As such, instances applicable to a credit card account herein may equally be considered applicable to a bank and/or debit card account.

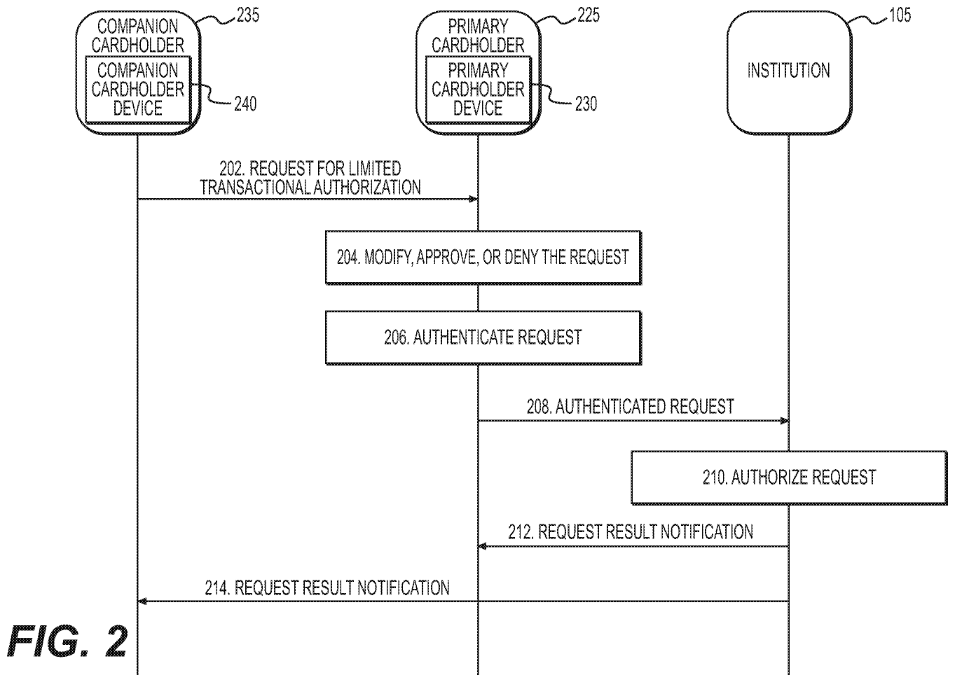

The third user 145 may include a vendor, merchant, or any other entity where the first user 125 and/or the second user 135 may initiate a transaction. For example, the third user 145 may be a vendor and the second user 135 may be a customer. The second user 135 may be a companion cardholder for a credit card account where the first user 125 is the primary cardholder. The second user 135 may want to purchase an item or a service from the third user 145 using the credit card account. As the second user 135 is a non-authorized user, the first user 125 needs to grant limited transaction authorization in order for the second user 135 to complete the transaction. In some embodiments, the second user 135 may obtain approval from the first user 125 prior to initiating the transaction. In such embodiments, the second user 135 may be approved to use the credit card account for a certain period of time and/or up to a certain monetary amount to complete the transaction, as will be described in further detail below with reference to FIG. 2.

The first user device 130, the second user device 140, and the third user device 150 may communicate with the institution server systems 110 through the network 120. The first user device 130 and the second user device 140 may each include a computing system or device, such as the system 800 described with respect to FIG. 8. In an exemplary embodiment, the first user device 130 and the second user device 140 may each be a mobile device. As such, the first user device 130 and the second user device 140 may each include one or more processors and a memory for downloading, installing, and running mobile and/or desktop applications. The first user device 130 and the second user device 140 may each include a mobile and/or desktop application, such as a user application provided by the institution 105 via the one or more institution server systems 110. The user application may include, for example, one or more software modules for communicating with the institution server systems 110 through the network 120. In some embodiments, user applications on the first user device 130 and the second user device 140 may allow the first user 125 and the second user 135 to communicate with each other via the first and the second user devices 130, 140. In some embodiments, the first user device 130 and the second user device 140 may each include a touch sensitive interactive display.

In some embodiments, the first user 125 and/or the second user 135 may perform a process to create a public/private key pair, such as an enrollment process to a service provided by the institution 105, using the user application on the first user device 130 and the second user device 140. In such embodiments, the user application on the first user device 130 and the second user device 140 may be provided by the institution 105 via the one or more institution server systems 110. The service provided by the institution 105 (e.g., via the one or more institution server systems 110) may be an online platform on which limited transactional authorization from an account associated with the first user 125 may be granted to the second user 135. In some embodiments, the first user 125 may perform the enrollment process using the user application on the first user device 130. In some such enrollment processes, a public/private key pair may be formed. For example, the user application and/or the first user device 130 may generate a first key pair including a first private key and a first public key for the first user 125. The first private key may be stored in a secure data store of the first user device 130 and the first public key may be transmitted to the second user device 140, the institution 105 via the one or more institution server systems 110, and/or the third user device 150. The received first public key may be stored by the second user device 140, the institution 105 via the one or more institution server systems 110, and/or the third user device 150 in each respective data store.

It is contemplated that the first user 125 may lose the first user device 130, and/or may otherwise require a new user device. Accordingly, the stored first private key may also be lost or unusable. In such instances, the first user 125 may perform a recovery process when the first user 125 obtains a new first user device. In some embodiments, the recovery process may include generating a new first private key that is associated with the distributed first public key. The new first private key may be stored in a data store of the new first user device. In some embodiments, the recovery process may be provided by the institution 105 via the one or more institution server systems 110.

Similarly, the second user 135 may perform an enrollment process using the user application on the second user device 140, during which a public/private key pair may be generated. For example, the user application may generate a second key pair including a second private key and a second public key for the second user 135. The second private key may be stored in a secure data store of the second user device 140 and the second public key may be transmitted to the first user device 130, the institution 105 via the one or more institution server systems 110, and/or the third user device 150. The received second public key may be stored by the first user device 130, the institution 105 via the one or more institution server systems 110, and/or the third user device 150 in each respective data store.

In some instances, the second user 135 may lose the second user device 140, and/or may otherwise require a new user device. Accordingly, the stored second private key may also be lost or become unusable. In such instances, the second user 135 may perform a recovery process when the second user 135 obtains a new second user device. In some embodiments, the recovery process may include generating a new second private key that is associated with the distributed second public key. The new second private key may be stored in a data store of the new second user device. In some embodiments, the recovery process may be provided by the institution 105 via the one or more institution server systems 110.

The third user device 150 may include a computing system or device, such as the system 800 described with respect to FIG. 8. In some embodiments, the third user device 150 may include a point of sale (POS) device. However, the third user device 150 may include any type of computing device, such as a mobile and/or desktop computing device. As such, the third user device 150 may include one or more processors and a memory for downloading, installing, and running applications or software modules. The third user device 150 may further be in communication with one or more transaction vehicles, or encoded information readers, such as a magnetic card reading device, a radio-frequency identification (RFID) reading device, a near-field communication (NFC) reading device, a bar code reading device, or the like. It is understood that a single device (e.g., third user device 150) may encompass more than one transaction vehicle, such that the magnetic card reading device, biometrics reading device, RFID reading device, NFC reading device, and/or bar code reading device are a part of a single device. The third user device 150 may include a mobile and/or desktop application, such as a user application provided by the institution 105 via the institution server systems 110, or any suitable third party mobile and/or desktop application for performing desired functions of the third user device 150 (e.g., a POS application). In some embodiments, an application of the third user device 150 may include, for example, one or more software modules for communicating with the institution server systems 110 through the network 120. In further embodiments, an application of the third user device 150 need not include any software modules for communicating with the institution server systems 110 and/or the institution 105. In some embodiments, the third user device 150 may include a touch sensitive interactive display.

FIG. 2 is a flowchart illustrating a method for granting limited transactional authorization from an account associated with a primary cardholder 225, e.g., a first user 125, and a companion cardholder 235, e.g., a second user 135, according to some embodiments. As described above, the companion cardholder 235 may be a non-authorized user added to a credit card account held by the primary cardholder 225. In some embodiments, the financial institution 105 may issue a companion credit card for the companion cardholder 235 in addition to a primary credit card issued for the primary cardholder 225.

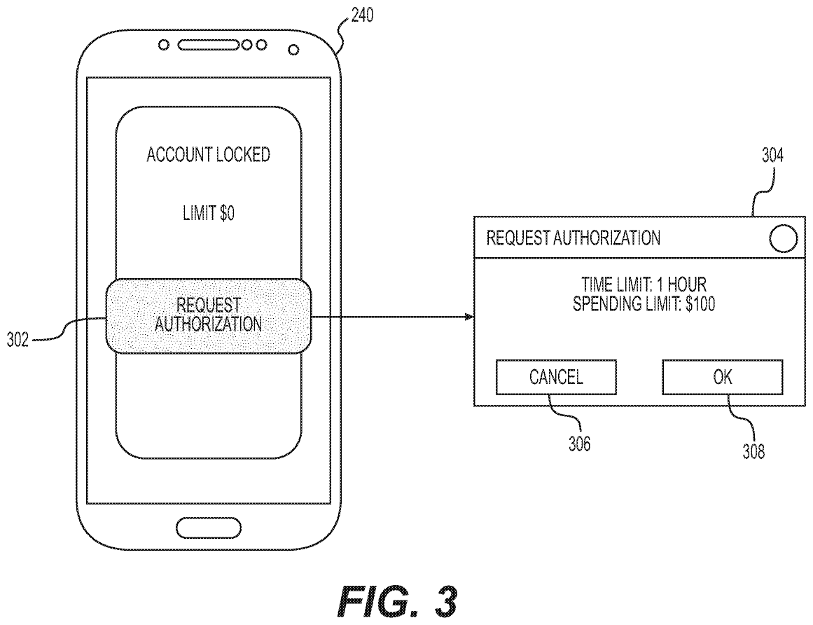

In step 202, the companion cardholder 235 may request limited transactional authorization from the credit card account associated with the primary cardholder 225. For example, the companion cardholder 235 may request permission from the primary cardholder 225 prior to making any transactions using the credit card account. The request may include a requested amount and/or a period of time for the limited transactional authorization. In some embodiments, the request may further include a requested location at which to perform the transaction, and/or a requested user with which to perform a transaction. For example, the request may include a request to initiate the transaction with third user 145. In some embodiments, the companion cardholder 235 may transmit the request via a companion cardholder device 240, e.g., second user device 140. In such embodiments, the primary cardholder 225 may receive the transmitted request at a primary cardholder device 230, e.g., first user device 130. For example, the companion cardholder 235 may transmit the request via a user interface on the companion cardholder device 240, as will be described in further detail below with reference to FIG. 3.

In some embodiments, the companion cardholder 235 may be prompted to perform an authentication process, e.g., via the companion cardholder device 240 prior to transmitting the request. Such an authentication process may serve to, e.g., verify the identity of the companion cardholder 235. In such embodiments, the companion cardholder 235 may be permitted to transmit the request after a successful authentication. It is understood that the authentication process may be performed utilizing any appropriate authentication method. For example, an authentication process may include a password-enabled authentication process and/or a biometric authentication performed through fingerprint sensing, facial recognition, iris scanning, or the like. The authentication process may additionally, or alternatively, include a motion detection on the companion cardholder device 240. As yet another example, the authentication method may include a two-factor authentication process, such as a two-step authentication process utilizing a combination of an email, a phone call, and/or text messages.

As a result of successfully performing the authentication process, a private key issued to the companion cardholder 235 (e.g., the second private key described above with reference to FIG. 1) may be retrieved from a data store of the companion cardholder device 240 and used to generate a digital signature for the request 202, according to some embodiments. Accordingly, the generated digital signature may be transmitted along with the request 202 to the primary cardholder 225.

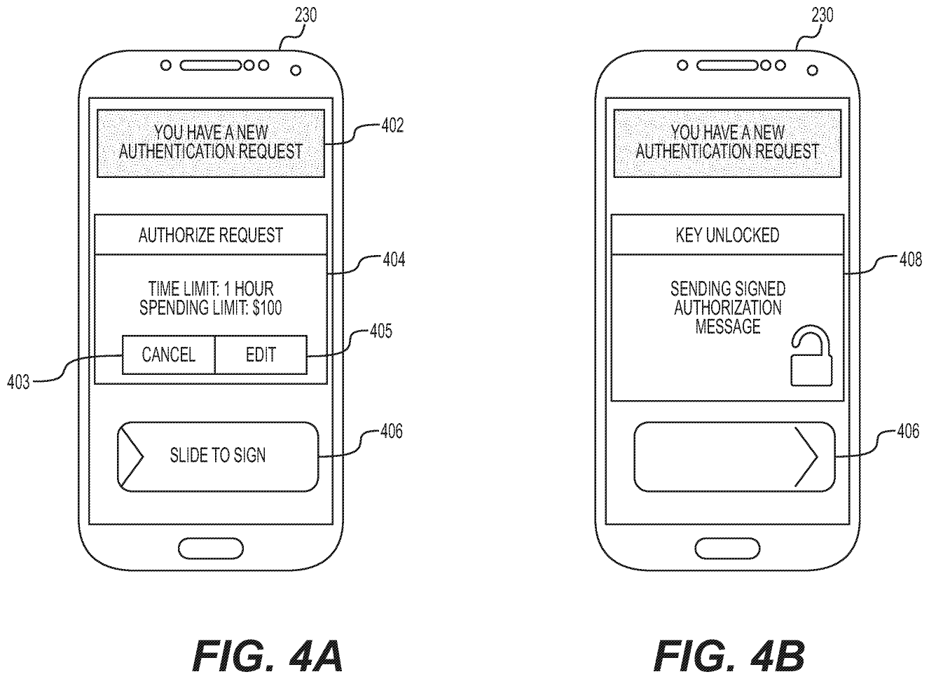

The primary cardholder 225 may then receive the request via a user interface on the primary cardholder device 230, as will be described in further detail below with reference to FIG. 4A. In some embodiments, a verification process may be performed to determine the authenticity of the received request. For example, a request transmitted by the companion cardholder 235 via the companion cardholder device 240 may include the digital signature as described above. In such instances, the received digital signature may need to be verified. In some embodiments, a public key issued to the companion cardholder 235 (e.g., the second public key described above with reference to FIG. 1), which may be paired with the private key of the companion cardholder 235, may be retrieved from a data store of the primary cardholder device 230. The retrieved public key may be used to decrypt the received digital signature, thereby verifying that the digital signature was created by the companion cardholder 235 using their private key, i.e., the request had been transmitted by the companion cardholder 235. It is understood that the verification method is described simply for the purpose of explanation and any appropriate variation on the public/private key and digital signature creation/verification process may be utilized in alternative embodiments. While the use of the first and second user devices 130, 140 is described with reference to step 202, it is understood that the companion cardholder 235 may request permission from the primary cardholder 225 using any other appropriate method in alternative embodiments. For example, the companion cardholder 235 may make a verbal request to the primary cardholder 225 in person. In some embodiments, the companion cardholder 235 may not request permission from the primary cardholder 225 (e.g., the primary cardholder 225 may authorize a transaction type, location, and/or amount for a companion cardholder independently of any request to do so).

In step 204, the primary cardholder 225 may modify, approve, or deny the request made by the companion cardholder 235 (or, as described previously, may grant authorization to the companion cardholder independent of a request). For example, the primary cardholder 225 may modify the requested amount, period of time, and/or location (e.g., the requested third user 145) for the limited transactional authorization requested by the companion cardholder 235. As another example, the primary cardholder 225 may approve or deny the requested amount, period of time, and/or location (e.g., the requested third user 145) for the limited transactional authorization requested by the companion cardholder 235. In some embodiments, the primary cardholder 225 may approve an amount and a location requested by the companion cardholder 235, but modify the requested period of time. For example, the primary cardholder 225 may approve the requested amount to be spent at a vendor, but adjust the requested time to complete the transaction. In some embodiments, the request may not include details regarding the limited transactional authorization. For example, the request may be a general request for limited transaction authorization and not include a specific period of time, amount, and/or location. In such embodiments, the primary cardholder 225 may determine the amount, period of time, and/or location for the limited transaction authorization. In some embodiments, the primary cardholder 225 may modify, approve, or deny the request via a user interface on the primary cardholder device 230, as will be described in further detail below with reference to FIG. 4A.

Once the primary cardholder 225 modifies and/or approves the request (hereinafter referred to as the “reviewed request”), the primary cardholder 225 may authenticate the reviewed request to be transmitted to the financial institution for verification. In some embodiments, the authentication process may include prompting the primary cardholder 225 to complete an authentication process via, for example, the primary cardholder device 230, to authenticate the reviewed request. In some embodiments, the authentication process may include biometric authentication performed through fingerprint sensing, facial recognition, and/or iris scanning, among others. The authentication process may additionally, or alternatively, include a motion detection on the primary cardholder device 230, for example, a swipe motion on the primary cardholder device 230 as described in further detail with reference to FIGS. 4A-4B. The authentication process may additionally, or alternatively, include requiring entry of a password or passcode on the primary cardholder device 230. It is understood that the authentication process may be performed utilizing any appropriate authentication method in alternative embodiments. In some embodiments, the authentication method may include a two-factor authentication process utilizing, for example, a two-step combination of an email, phone call, and/or text messages. Upon successful authentication, a private key issued to the primary cardholder 225 (e.g., the first private key described above with reference to FIG. 1) may be retrieved from a data store of the primary cardholder device 230 and used to create a digital signature for the request. The generated digital signature may be combined with the request, thereby forming the authenticated request (also referred to as an encrypted request). The authenticated request may then be transmitted to the financial institution 105, as shown in step 208 of FIG. 2A.

In some embodiments, the request made by the companion cardholder 235 in step 202 may be denied by the primary cardholder 225. In such embodiments, the primary cardholder 225 may transmit a notification of the denied request to the companion cardholder 235. In some embodiments, the notification of the denied request may be transmitted via the primary cardholder device 230 and received by the companion cardholder 235 via the companion cardholder device 240. In such embodiments, the notification of the denied request may be displayed on the companion cardholder device 240. In some embodiments, the primary cardholder 225 may perform an authentication process, as described herein, to authenticate the notification of the denied request. Upon successful authentication, the private key issued to the primary cardholder 225 (e.g., the first private key described above with reference to FIG. 1) may be retrieved from the data store of the primary cardholder device 230 and used to create a digital signature for the notification. The digital signature may be combined with the notification and transmitted to the companion cardholder 235. Upon receipt, the companion cardholder 235 may verify that the notification has been transmitted by the primary cardholder 225. In some embodiments, a public key issued to the primary cardholder 225 (e.g., the first public key described above with reference to FIG. 1), which may be linked to the private key of the primary cardholder 225, may be retrieved from the secure data store of the companion cardholder device 240. The retrieved public key may be used to decrypt the received digital signature, thereby verifying that the digital signature was created by the primary cardholder 225 using their private key, i.e., the request had been transmitted by the primary cardholder 225.

In step 210, the financial institution 105 may authorize the received request. In some embodiments, the received request may include the generated digital signature, as described above. In such embodiments, the public key issued to the primary cardholder 225 (e.g., the first public key described above with reference to FIG. 1), which may be linked to the private key of the primary cardholder 225, may be retrieved from the databases 115. The retrieved public key may be used to decrypt the received digital signature, thereby verifying that the digital signature was created by the primary cardholder 225 using their private key, i.e., the request had been transmitted by the primary cardholder 225. As a result of successful verification, the financial institution 105 may authorize the request. In some embodiments, the financial institution 105 may authorize the verified request by temporarily unlocking the credit card account associated with the primary cardholder 225 in accordance to the information (e.g., an identity of the companion cardholder 235, a requested amount, a requested period of time, and/or a requested location) included in the request.

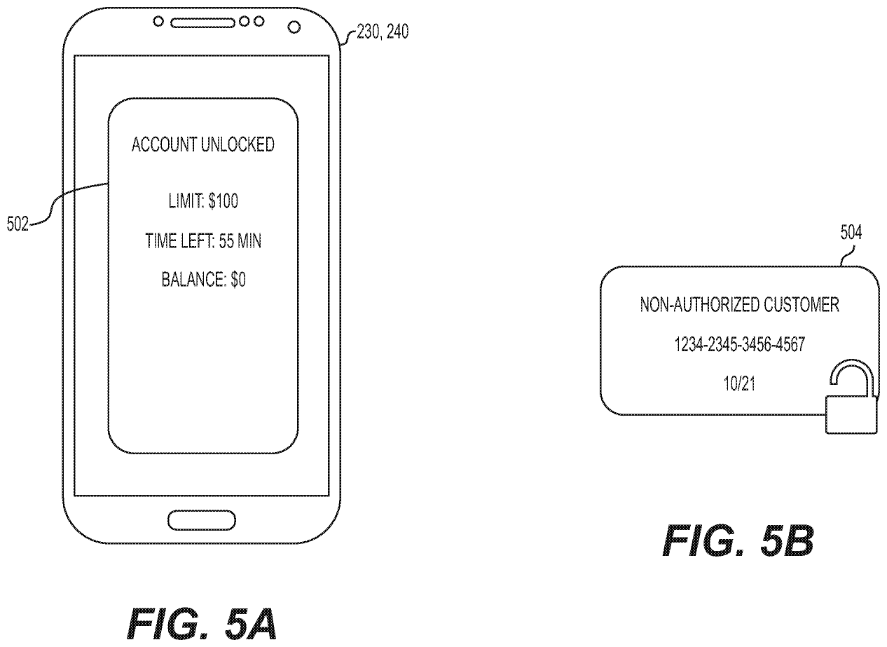

In some embodiments, the financial institution 105 may transmit a notification to the primary cardholder 225 and/or the companion cardholder 235 regarding the temporary authorization for the companion cardholder's 235 use of the credit card account, as shown in steps 212 and 214 of FIG. 2A. In some embodiments, the primary cardholder 225 and the companion cardholder 235 may receive the notification via the primary cardholder device 230 and companion cardholder device 240, respectively, as will be described in further detail below with reference to FIGS. 5A-5B. Once authorized, the companion cardholder 235 may be granted limited transactional authorization to use the credit card account. That is, the companion cardholder 235 may initiate and complete one or more transactions in accordance to the approved limited transactional authorization.

FIG. 3 depicts a user interface on a companion cardholder device 240 according to some embodiments. The companion cardholder 235 may transmit a request for limited transactional authorization using the companion cardholder device 240. In some embodiments, the user interface of the companion cardholder device 240 may display a current amount authorized for use by companion card holder 235 and/or a notification that the credit card account associated with the primary cardholder 225 is currently locked, i.e., the companion card holder 235 is not authorized to perform a transaction using the credit card account. The user interface of the companion cardholder device 240 may include a request authorization object 302. The companion card holder 235 may access the request authorization object 302 using the touch sensitive display (e.g., by pressing the request authorization object 302), resulting in a transition to a request authorization interface. In some embodiments, the request authorization interface may include a request authorization confirmation interface 304. As shown in FIG. 3, the request authorization confirmation interface 304 may display a requested period of time for at least one transaction and/or a requested amount for the at least one transaction. In some embodiments, the request authorization confirmation interface 304 may further display a requested location for the at least one transaction. The request authorization confirmation interface 304 may include a cancel object 306 and a transmit object 308. The companion cardholder 235 may cancel the limited transactional authorization request by pressing the cancel object 306. Similarly, the companion card holder 235 may transmit the limited transactional authorization request to the primary card holder by pressing the transmit object 308.

FIGS. 4A-4B depict a user interface on a primary cardholder device 230 according to some embodiments. The primary cardholder 225 may receive a limited transactional authorization request at the primary cardholder device 230. In some embodiments, the user interface of the primary cardholder device 230 may display or otherwise provide a notification 402 that a limited transactional authorization request has been received. The user interface of the primary cardholder device 230 may include an authorize request interface 404. As shown in FIG. 4A, the authorize request interface 404 may include a cancel object 403 and/or an edit object 405. The primary card holder 225 may deny the limited transactional authorization request by pressing the cancel object 403. The primary card holder 225 may modify the limited transactional authorization request by pressing the edit object 405. In some embodiments, pressing the edit object 405 may result in a transition to a request modification interface, in which the primary card holder 225 may modify the requested period of time for at least one transaction and the requested amount for the at least one transaction, and/or the requested location for the at least one transaction.

The user interface of the primary cardholder device 230 may further include an authentication object 406. The primary cardholder 225 may authenticate and transmit the request for authorization by accessing the authentication object 406 (e.g., pressing and sliding a finger from one end to the other end of the authentication object 406), resulting in a display of a send authorization request notification 408, as shown in FIG. 4B. As described above with reference to step 206 of FIG. 2, accessing the authentication object 406 may authenticate the limited transactional authorization request and, upon successful authentication, a private key associated with the primary cardholder 225 may be retrieved from, e.g., the data store of the primary cardholder device 230 and used to generate a digital signature for the request prior to transmission to the financial institution 105. The send authorization request notification 408 may include a notification that the private key has been “unlocked,” e.g., that the private key has been retrieved to generate the digital signature, and another notification that the limited transactional authorization request including the digital signature is being securely transmitted to the financial institution 105.

FIGS. 5A-5B depict a user interface on a primary cardholder device 230 and/or a companion cardholder device 240 according to some embodiments. The primary cardholder device 230 and/or the companion cardholder device 240 may receive a notification 502 regarding the temporary authorization for the companion cardholder's 235 use of the primary cardholder's 225 credit card account. As shown in FIG. 5A, the notification 502 may include a notification that the primary cardholder's credit card account has been unlocked, i.e., the companion cardholder 235 has been authorized for limited transactions. The notification 502 may further display the approved amount for the requested limited transaction, the time remaining for the approved period of time for the requested limited transaction, and a balance of the approved amount that has been spent. In some embodiments, notification 502 may further display the approved location for the requested limited transaction. In some embodiments, the user interface on the primary cardholder device 230 and/or the companion cardholder device 240 may further display the name of the companion cardholder 235 and primary cardholder's credit card account information (e.g., credit card account number and expiration date), as shown in FIG. 5B.

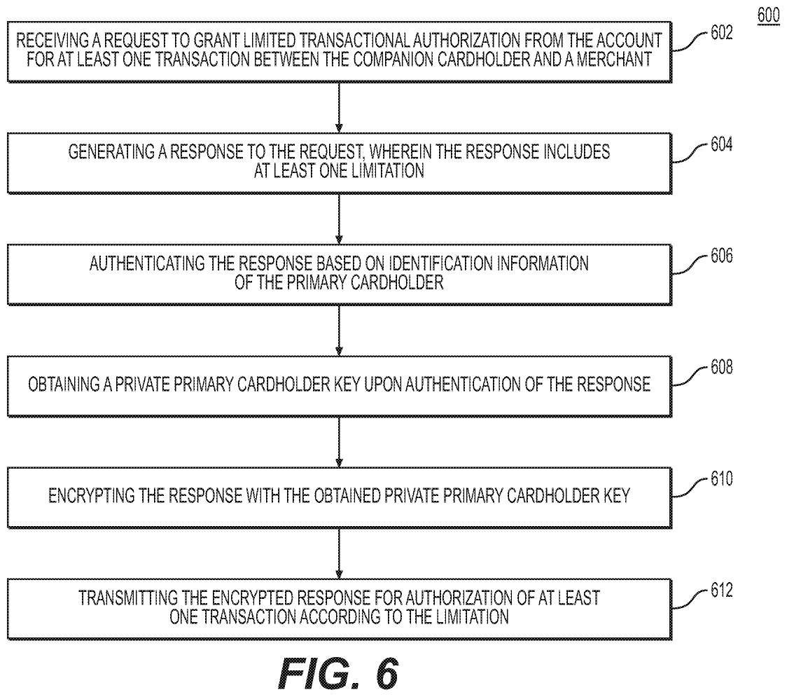

FIG. 6 depicts a flowchart of an exemplary process 600 for granting limited transactional authorization from an account associated with a primary cardholder and a companion cardholder according to one or more embodiments, and may be performed in, e.g., the exemplary environment of FIG. 1. Process 600 may begin with step 602, in which a request to grant limited transactional authorization from the account for at least one transaction between the companion cardholder and a merchant may be received. In some embodiments, the request to grant limited transactional authorization may be transmitted via a companion cardholder device associated with the companion cardholder. In step 604, a response to the request may be generated, where the response may include at least one limitation. In some embodiments, the response comprises an approval, a modification, or a denial of the request. In some embodiments, the limitation may include at least one of an amount limitation, a period of time limitation, or a location limitation associated with the at least one transaction.

In step 606, the response may be authenticated based on identification information of the primary cardholder. In some embodiments, authenticating the response based on identification information of the primary cardholder may include: obtaining the identification information from the primary cardholder, comparing the obtained identification information with stored identification information, and authenticating the response upon a determination of a match between the obtained identification information and the stored identification information. In some embodiments, the obtained identification information may include a biometric feature of the primary cardholder, and the stored identification information may include a stored biometric feature of the primary cardholder. In some embodiments, the obtained identification information may include a motion pattern, and the stored identification information may include a predetermined motion pattern. In some embodiments, the obtained identification and stored identification information may include a password or passcode. In some embodiments, the authentication step 606 may be performed as a two-factor authentication process utilizing, for example, a two-step combination of an email, phone call, and/or text messages. In such embodiments, the obtained identification and stored identification information may include an email address and/or a phone number associated with the primary cardholder.

In step 608, a private primary cardholder key may be obtained upon authentication of the response. In step 610, the response may be encrypted with the obtained private primary cardholder key. In some embodiments, encrypting the response with the obtained private primary cardholder key may include using the private primary cardholder key to generate a digital signature and combining the generated digital signature with the response, where a public primary cardholder key may be associated with the private cardholder key. In some embodiments, the digital signature may be configured to be decrypted using the public primary cardholder key. In step 612, the encrypted response may be transmitted for authorization of the at least one transaction according to the limitation. In some embodiments, transmitting the encrypted response may include transmitting the generated digital signature.

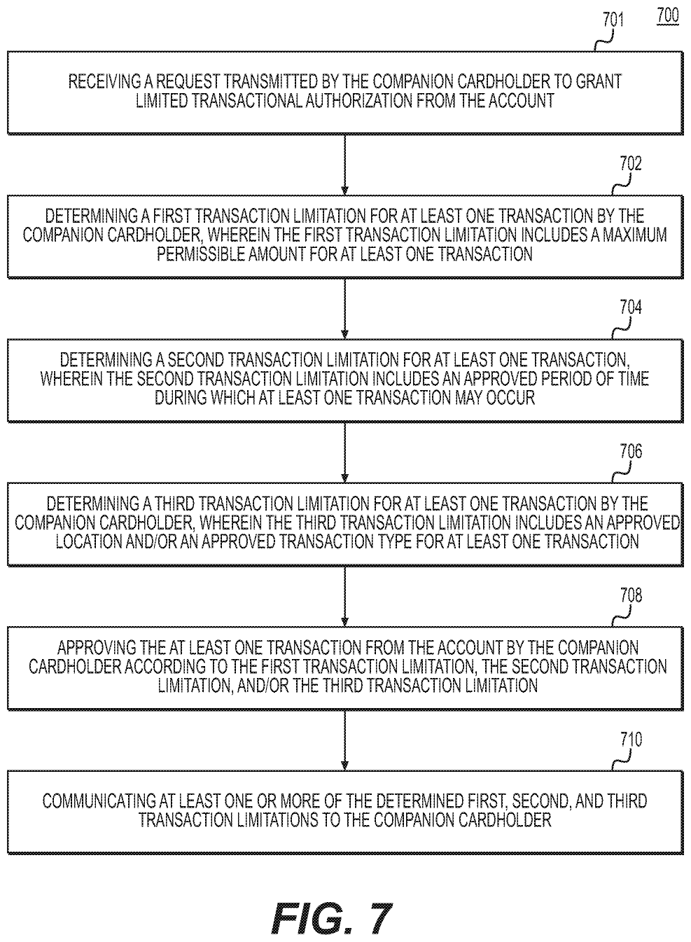

FIG. 7 depicts a flowchart of an exemplary process 700 for granting limited transactional authorization from an account associated with a primary cardholder and a companion cardholder according to one or more embodiments, and may be performed in the exemplary environment of FIG. 1. In some embodiments, process 700 may be performed by a primary cardholder device associated with the primary cardholder. Process 700 may, in some embodiments, begin with step 701, in which a request transmitted by, e.g., a companion cardholder to grant limited transactional authorization from an account may be received. In further embodiments, process 700 may begin with step 702, a first transaction limitation for at least one transaction by the companion cardholder may be determined. The first transaction limitation may include a maximum permissible amount for the at least one transaction. In step 704, a second transaction limitation for the at least one transaction may be determined. In some embodiments, the second transaction limitation may include an approved period of time during which the at least one transaction may occur. In step 706, a third transaction limitation for the at least one transaction by the companion cardholder may be determined. In some embodiments, the third transaction limitation may include, e.g., an approved location for the at least one transaction, such as an approved merchant or an approved geographic location. In some embodiments, the third transaction limitation may include, e.g., an approved transaction type, such as a type of purchase (e.g., groceries, travel, etc.). In step 708, the at least one transaction from the account by the companion cardholder may be approved according to the first transaction limitation, the second transaction limitation, and/or the third transaction limitation.

In some embodiments, process 700 further includes step 710, in which at least one or more of the determined first, second, and third transaction limitations may be communicated to the companion cardholder. It is to be understood that while three transaction limitations are discussed with respect to process 700, any suitable number of transaction limitations may be presented and/or approved.

As noted previously, in some embodiments, process 700 includes step 701, in which a request transmitted by the companion cardholder to grant limited transactional authorization from the account may be received. In some embodiments, the request may include one or more of a requested amount for the at least one transaction and a requested period of time during which the at least one transaction may occur. In some embodiments, determining the first transaction limitation for the at least one transaction by the companion cardholder may be based on the requested amount. In some embodiments, determining the second transaction limitation for the at least one transaction by the companion cardholder may be based on the requested period of time. In some embodiments, determining the first transaction limitation based on the requested amount may include modifying the requested amount. In some embodiments, determining the second transaction limitation based on the requested period of time may include modifying the requested period of time. In some embodiments, the request may include a requested location at which the at least one transaction may occur and/or a requested type of transaction. In some embodiments, determining the third transaction limitation for the at least one transaction by the companion cardholder may be based on the requested location and/or the requested type of transaction. In some embodiments, determining the third transaction limitation based on the requested location and/or the requested type of transaction may include modifying the requested location and/or denying the requested type of transaction. In some embodiments, process 700 includes a further step in which the request to grant limited transactional authorization from the account may be declined.

As shown in FIG. 8, device 800 (e.g., first user device 130, second user device 140, third user device 150, and/or institution server systems 140) may include a central processing unit (CPU) 820. CPU 820 may be any type of processor device including, for example, any type of special purpose or a general-purpose microprocessor device. As will be appreciated by persons skilled in the relevant art, CPU 820 also may be a single processor in a multi-core/multiprocessor system, such system operating alone, or in a cluster of computing devices operating in a cluster or server farm. CPU 820 may be connected to a data communication infrastructure 810, for example, a bus, message queue, network, or multi-core message-passing scheme.

Device 800 also may include a main memory 840, for example, random access memory (RAM), and also may include a secondary memory 830.

Secondary memory 830, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 830 may include other similar means for allowing computer programs or other instructions to be loaded into device 800. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 800.

Device 800 also may include a communications interface (“COM”) 860. Communications interface 860 allows software and data to be transferred between device 800 and external devices. Communications interface 860 may include a modem, a network interface (such as an Ethernet card), a communications port, a PCMCIA slot and card, or the like. Software and data transferred via communications interface 860 may be in the form of signals, which may be electronic, electromagnetic, optical, or other signals capable of being received by communications interface 860. These signals may be provided to communications interface 860 via a communications path of device 800, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 800 also may include input and output ports 850 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order (e.g., steps may be added, removed, or repeated), or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

1. A method of granting limited transactional authorization from an account associated with a primary cardholder and a companion cardholder, the method comprising:
receiving, via one or more processors, an encrypted request transmitted by a companion cardholder device associated with the companion cardholder to grant limited transactional authorization from the account for at least one transaction between the companion cardholder and a merchant;
upon receipt of the encrypted request, retrieving, by the one or more processors, a public key associated with the companion cardholder device;
decrypting, by the one or more processors, the received encrypted request using the retrieved public key;
generating, via the one or more processors, a response to the decrypted request, wherein the response includes at least one limitation;
authenticating, via the one or more processors, the response based on identification information of the primary cardholder;
upon authentication of the response, obtaining, via the one or more processors, a private primary cardholder key;
encrypting, via the one or more processors, the response with the obtained private primary cardholder key; and
transmitting, via the one or more processors, the encrypted response for authorization of the at least one transaction between the companion cardholder and the merchant according to the limitation.

2. The method of claim 1, wherein the limitation includes at least one of an amount limitation, a period of time limitation, or a location limitation associated with the at least one transaction.

3. The method of claim 1, wherein the response comprises an approval, a modification, or a denial of the request.

4. The method of claim 1, wherein authenticating the response based on identification information of the primary cardholder comprises:
obtaining the identification information from the primary cardholder;
comparing the obtained identification information with stored identification information; and
authenticating the response upon a determination of a match between the obtained identification information and the stored identification information.

5. The method of claim 4, wherein the obtained identification information comprises a biometric feature of the primary cardholder, and wherein the stored identification information comprises a stored biometric feature of the primary cardholder.

6. The method of claim 4, wherein the obtained identification information comprises a motion pattern, and wherein the stored identification information comprises a predetermined motion pattern.

7. The method of claim 1, wherein a primary cardholder device associated with the primary cardholder comprises the one or more processors and a memory.

8. The method of claim 1, wherein encrypting the response with the obtained private primary cardholder key comprises:
using the private primary cardholder key to generate a digital signature; and
combining the generated digital signature with the response, wherein a public primary cardholder key is associated with the private primary cardholder key.

9. The method of claim 8, wherein the digital signature is configured to be decrypted using the public primary cardholder key.

10-20. (canceled)

21. A computer system for granting limited transactional authorization from an account associated with a primary cardholder and a companion cardholder, the computer system comprising:
a data storage device storing processor-readable instructions; and
a processor configured to execute the instructions to perform a method including:
receiving an encrypted request transmitted by a companion cardholder device associated with the companion cardholder to grant limited transactional authorization from the account for at least one transaction between the companion cardholder and a merchant;
upon receipt of the encrypted request, retrieving a public key associated with the companion cardholder device;
decrypting the received encrypted request using the retrieved public key;
generating a response to the decrypted request, wherein the response includes at least one limitation;
authenticating the response based on identification information of the primary cardholder;
upon authentication of the response, obtaining a private primary cardholder key;
encrypting the response with the obtained private primary cardholder key; and
transmitting the encrypted response for authorization of the at least one transaction between the companion cardholder and the merchant according to the limitation.

22. The computer system of claim 21, wherein the limitation includes at least one of an amount limitation, a period of time limitation, or a location limitation associated with the at least one transaction.

23. The computer system of claim 21, wherein the response comprises an approval, a modification, or a denial of the request.

24. The computer system of claim 21, wherein authenticating the response based on identification information of the primary cardholder comprises:
obtaining the identification information from the primary cardholder;
comparing the obtained identification information with stored identification information; and
authenticating the response upon a determination of a match between the obtained identification information and the stored identification information.

25. The computer system of claim 24, wherein the obtained identification information comprises a biometric feature of the primary cardholder, and wherein the stored identification information comprises a stored biometric feature of the primary cardholder.

26. The computer system of claim 24, wherein the obtained identification information comprises a motion pattern, and wherein the stored identification information comprises a predetermined motion pattern.

27. (canceled)

28. The computer system of claim 21, wherein encrypting the response with the obtained private primary cardholder key comprises:
using the private primary cardholder key to generate a digital signature; and
combining the generated digital signature with the response, wherein a public primary cardholder key is associated with the private primary cardholder key.

29. The computer system of claim 28, wherein the digital signature is configured to be decrypted using the public primary cardholder key.

30. A non-transitory computer-readable medium containing instructions for granting limited transactional authorization from an account associated with a primary cardholder and a companion cardholder that, when executed by a processor, cause the processor to perform a method comprising:
receiving an encrypted request transmitted by a companion cardholder device associated with the companion cardholder to grant limited transactional authorization from the account for at least one transaction between the companion cardholder and a merchant;
upon receipt of the encrypted request, retrieving a public key associated with the companion cardholder device;
decrypting the received encrypted request using the retrieved public key;
generating a response to the decrypted request, wherein the response includes at least one limitation;
authenticating the response based on identification information of the primary cardholder;
upon authentication of the response, obtaining a private primary cardholder key;
encrypting the response with the obtained private primary cardholder key; and
transmitting the encrypted response for authorization of the at least one transaction between the companion cardholder and the merchant according to the limitation.

31. (canceled)

32. The method of claim 1, wherein the public key associated with the companion cardholder device is retrieved from a data store of a primary cardholder device associated with the primary cardholder.
